(19) United States
(12) Patent Application Publication
(10) Pub. No.: US 2008/0000342 A1
(43) Pub. Date: Jan. 3, 2008

(54) Soundboard for Acoustic Guitar

(76) Inventor: Juan Menduina Fernandez, Madrid (ES)

Correspondence Address: LADAS & PARRY, 26 WEST 61ST STREET, NEW YORK, NY, 10023, US

(21) Appl. No.: 11/587,019

(22) PCT Filed: Apr. 10, 2005
(86) PCT No.: PCT/ES05/00201

§ 371 Date: Aug. 22, 2007

(30) Foreign Application Priority Data
Apr. 20, 2004 (ES) U-200400935

(51) Int. Cl. G10D 3/00

(52) U.S. Cl. 84/291

(57) ABSTRACT

The invention relates to a soundboard for acoustic guitars. Until now, empirical-type criteria have been used to construct soundboards (8) for acoustic guitars, however, the invention employs physical and harmonic frequency criteria by taking account of the technological characteristics of the woods used to construct the soundboard (8). According to the invention, tension compensation is provided by distribution in a bent structure (bent fan bracing (13)) or with floating fan bracing (12) which is glued on top of the bent fan bracing (13) such as to enable the board to vibrate, while simultaneously conferring mechanical strength on same in the direction of pull. In this way, the invention relates to the use of bent fan bracing (13) which is glued to the soundboard (8) perpendicularly to the grain of the wood (16), such as to delimit different wood grain (16) lengths, defining what has been described as harmonic uses of frequencies (15). Obviously, depending on the desired harmonic characteristics, the harmonic uses of frequencies (15) can be open, closed, complete, incomplete, symmetrical, asymmetrical, concave, convex, concave plane, convex plane, etc. and, in addition, the number and distribution thereof can vary. Finally, the floating fan braces (12), which are glued to the above-mentioned fan bracing, perform three functions, namely: providing the soundboard (8) with mechanical strength, acting as a vibrating element, and moderating low and/or high frequencies, thereby affecting the timbre of the instrument. Consequently, the number and position of floating fan braces can be varied according to the desired timbre and harmonic characteristics.

### DESCRIPTION

The present invention relates to a top soundboard for acoustic guitars.

### OBJECT OF THE INVENTION

The present Utility Model relates to the known instrument, a guitar, and within this group it relates to acoustic guitars, i.e. the sound is generated by the group of strings (nylon, steel), a soundbox.

The most known guitar in the world is the Spanish guitar in its two variants, the classical variant and the Flamenco variant, although there are other models that are also applicable regarding the present invention.

This instrument (the guitar) lacks tone, therefore despite being a concert instrument, when it forms part of a symphonic orchestra, amplification is required through electronic means, which covers up and distorts the beauty of its sound, and is not the natural and spontaneous sound of an instrument.

This Utility Model achieves greater tone without losing the typical pitches which provide it with its unique character.

### BACKGROUND OF THE INVENTION

The elements forming the guitar and included in FIG. 1 are as follows: the pegbox (1) which has the function of securing and tensing the strings at one of their ends, and under the pegbox is a piece called fingerboard “capo” or “bridge” (2), the purpose of which is to keep the strings lifted in the air together with the soundboard bridge (11) assembled on the soundboard (8).

The neck (4) forms a single element with the pegbox (1) and it ends in a piece called the heel (6), the function of which is to act as a support for the entire soundbox (10).

The fingerboard (5) is assembled on the mast (4) and has a series of metal strip separations called frets (3) which are spaced according to the tuning harmonic distances of the instrument.

The soundbox (10) is formed by the following main elements: the back or bottom (12), the soundboard (8) and two sides (7) forming the silhouette of the guitar and the purpose of which is to support the soundboard and the back.

The soundboard bridge (11) is fixed on the soundboard (8) and it is the other end where the strings are anchored to keep them lifted in the air and tensed. The sound hole (9) also opens out in this soundboard (8).

The most important tone element of the guitar is precisely the soundboard (8) and it is the object of the present Utility Model.

Soundboards (8) are made of wood of different types and gauges (thicknesses). The grain is oriented longitudinally, parallel to the string tensing direction (FIG. 2), as this is the direction of greatest mechanical resistance, withstanding the tensile stress of the strings.

The oldest method for obtaining these soundboards (8) was very simple and its object was to provide mechanical resistance both to the soundboard (8) and to the guitar in general; a series of straight braces (14) assembled perpendicularly to the grain of the wood which crossed the soundboard (8) from one side to the other, being supported on the sides (7). Today there are very few guitar players who still use this type.

At the end of the 19^{th} century, the model was modified, reducing the number of straight transverse braces to two and adding seven straight braces parallel to or having a certain angle (fan shape) with the grain of the wood, without being supported on the sides. The purpose thereof was to reinforce the soundboard (8) so that it did not become deformed when subjected to the stress of the strings and to thus be able to make it less thick.

There have been a countless number of variations in this model, such that they have been empirically adjusted according to the builder's likes.

Today, every guitar player virtually uses a variation of the original model and the fan is carried out by arranging seven, six, five, etc., braces, some of which maintain the two crossing the soundboard, and in other cases one crossing the soundboard obliquely is added; in some cases complex forms have been developed, such as the crow's foot, with a third brace under the soundboard bridge (11) from which others are derived.

The points for arranging them and the way of gauging them vary significantly and are defined only by the guitar player's experience.

Another known fact is the way the bodies vibrate. When a body is subjected to a stress which deforms it and suddenly stops, it vibrates to dissipate the deformation energy and does so with a frequency that is related to its elastic features and the vibration-free length (vibration arc) limited by the nodes at its ends.

### DESCRIPTION OF THE DRAWINGS

FIG. 1 shows plan and profile views of the main elements forming an acoustic guitar.

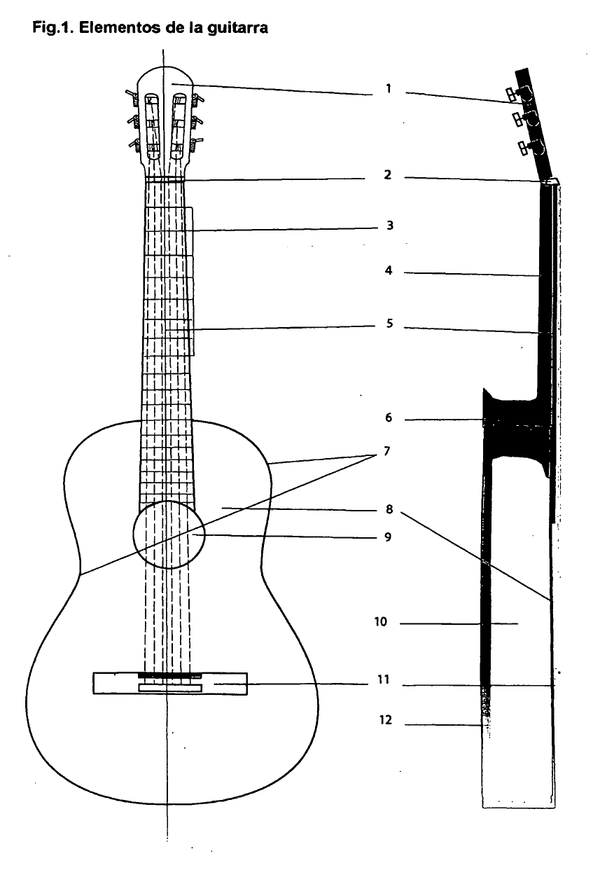

FIG. 2 shows an example of the construction of the inside of the soundboard with the braces that are claimed.

### DESCRIPTION OF THE INVENTION

The present Utility Model has been carried out by physical and mathematical processes and following frequency criteria, node spacing, elastic moduli, etc. and fully departs from previous models; it solves the drawbacks of mechanical resistance by distributing stress and seeks tone by considering wood to be a vibrating body with a certain elastic modulus with the ability to be stimulated by harmonics and thus resonate. The nodal points can be arranged with these criteria for fundamental music frequencies generated by the instrument, such that it considers that the alternating hard and soft grains of woods have different elastic moduli and act as if they were vibrating strings stimulated by the frequency of the musical note (fundamental frequency) that is being pressed.

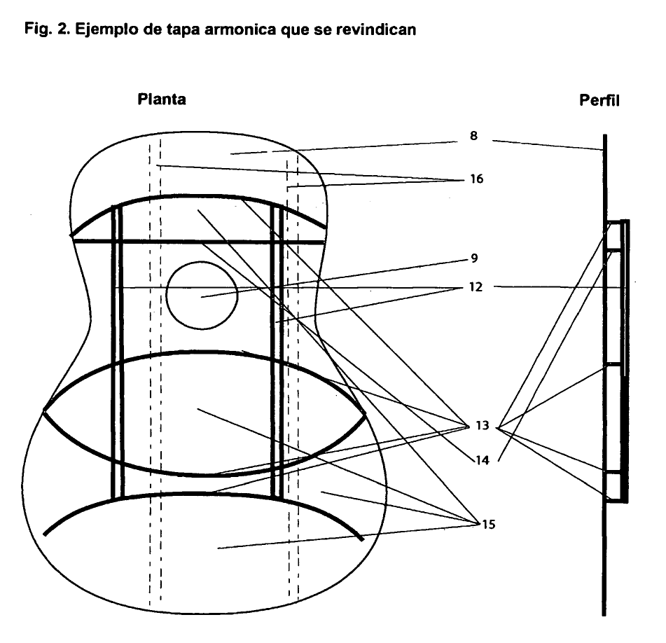

Due to the reasons set forth, the brace used in the construction of the soundboard (8) object of the present Utility Model is curved (FIG. 2) such that harmonic frequency uses (15) are demarcated, acting as resonators of the frequency of the musical note or notes pressed in each instant, and thus supporting the fundamental note with its harmonics.

Another feature of this Utility Model is the incorporation in the construction of the soundboard (8) of a floating brace (12) (FIG. 2) which is assembled on the braces assembled in the soundboard (8).

This floating brace (12) has three uses; first it is another vibrating element, second it controls the frequencies generated by the soundboard (8) such that it allows regulating the equilibrium between lows and highs (low and high frequencies), and third it provides greater mechanical rigidity to the soundboard (8).

According to the foregoing, in this Utility Model being claimed a number of variations are possible due to its working with frequencies and because the problems of mechanical resistance of the soundboard (8) are solved, such that it enables tuning the instrument at a certain frequency or tone with the suitable combination of the following thickening elements of the soundboard (8), spacing and gauging of the curved braces and/or combined with straight braces (14) and/or floating brace (12), according to the elastic modulus of the wood with which the soundboard (8) is built.

The pitch of the instrument, spontaneity, amplitude and other features can also be controlled by the combination of the thickness or gauge of the soundboard (8) and by the situation of the curved, straight or floating braces (13), (14) and (12), such that high pitches, dark pitches, pitches rich in bass sounds, etc., can be obtained.

1. A soundboard for acoustic guitars, characterized by the use of curved braces (13) with or without supports on the sides (7), demarcating one or several harmonic uses (15) which can be open or closed at the ends, symmetrical or asymmetrical, concave or convex and with the major axis perpendicular or oblique with respect to the grain of the wood and defined by the curved or straight brace/braces (13), (14).

2. A soundboard for acoustic guitars according to claim 1, characterized by the use of a floating brace (12).
